(19) United States
(12) Patent Application Publication
(10) Pub. No.: US 2008/0195963 A1
(43) Pub. Date: Aug. 14, 2008

(54) Engineering System

(76) Inventors: Wolfgang Eisen, Bischweier (DE); Holger Rachut, Karlsruhe (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/885,354

(22) PCT Filed: Feb. 24, 2006
(86) PCT No.: PCT/EP06/60261

§ 371 Date: Aug. 30, 2007

(30) Foreign Application Priority Data
Mar. 1, 2005 (DE) 10 2005 009 380.9
Jun. 20, 2005 (DE) 10 2005 028 488.4

(51) Int. Cl. G06F 3/048

(52) U.S. Cl. 715/772

(57) ABSTRACT

There is described an engineering system for an automation system having data required for engineering the automation system stored in the engineering system, and a determination device to determine automatically in response to a user request from the engineered automation system, maintenance-relevant information for display in a diagnostics area on a visualization system. Furthermore there is described a method for maintaining an automation system having components, wherein the components are connected to an engineering system and maintenance-relevant information is determined by the engineering system. The maintenance-relevant information can be displayed by the engineering system.

### CROSS REFERENCE TO RELATED APPLICATIONS

This application is the US National Stage of International Application No. PCT/EP2006/060261, filed Feb. 24, 2006 and claims the benefit thereof. The International Application claims the benefits of German application No. 10 2005 009 380.9 DE filed Mar. 1, 2005, and German application No. 10 2005 028 488.4 DE filed Jun. 20, 2005, all of the applications are incorporated by reference herein in their entirety.

### FIELD OF INVENTION

The invention relates to an engineering system for engineering and/or configuring a project representing an automation mechanism of a plant to be controlled, wherein the project data required for engineering and/or configuring the automation mechanism can be stored in the engineering system.

### BACKGROUND OF INVENTION

An engineering system of this kind is known from the Siemens catalog ST PCS 7, Sections 1 and 4, 2004 edition. A process control system for controlling a plant incorporates an engineering system which is particularly designed for configuring hardware and/or software components, engineering communication networks, engineering continuous and sequential process flows, and also for designing operator control and monitoring strategies and creating recipes for batch processes. The required project data for the engineering and/or configuring of a project representing the automation mechanism to be designed can be stored e.g. in a memory of a programmer or server, the programmers involved in the engineering and/or configuring in a multiuser operation being able to access this common memory. The project can also be subdivided into a plurality of subprojects which are engineered and/or configured on different programmers. The project data of a subproject is stored on the programmer on which the subproject was engineered and/or configured. Only data records indicating which subprojects are operatively connected to which programmers are stored centrally, these data records being readable by the programmers.

Also known from the abovementioned Siemens catalog ST PCS 7 is a so-called Process Device Manager which is intended particularly for diagnostics and servicing of intelligent field devices (sensors, actuators) and field components (remote I/Os, multiplexers, compact controllers, panel instruments). The separate handling of the engineering and/or configuring of a project representing an automation mechanism of a plant to be controlled (technology view) on the one hand, and the engineering of diagnostic and maintenance actions on the other, is prone to error.

### SUMMARY OF INVENTION

An object of the present invention is to specify an engineering system of the type mentioned in the introduction which simplifies the engineering of components of an automation mechanism in respect of diagnostics and/or maintenance of said components.

This object is achieved by the actions set forth in an independent claim.

It is advantageous that by means of the invention a uniform platform is created in respect of the technology and diagnostic and/or maintenance view. The user is able to clearly identify and assess the components of the automation mechanism. In the case of a deviation from a desired state of a component, suitable actions are provided. A suitable maintenance action can be, for example, as a function of the degree of wear of a component, indicating said degree of wear in good time. Said component having a high degree of wear must be replaced, thereby avoiding plant downtime.

Further advantageous embodiments the invention will emerge from the other sub-claims.

In an advantageous embodiment of the invention, maintenance-relevant data of at least one component of the automation mechanism can be entered in the engineering system. It is provided according to the invention that the individual components of the automation system are assigned maintenance-relevant data. This data can include, for example, the age of a component or the operating time of a component. After a period of time that can be set for each component, it can be indicated according to the invention that the component must be replaced or maintained. It is also provided according to the invention that the maintenance-relevant data of the components is stored in an electronic library in the form of data records. The possibility of modifying the data or creating new data records means that each component can be entered in the system so that there is no limitation in the selection of the components.

In a further development of the invention, at least one component of the automation mechanism is provided with means of transferring maintenance-relevant information to the engineering system. This maintenance-relevant data can include, for example, the operating time of a component, the over- or undershooting of a threshold value or specific information concerning maintenance. It is also provided that a data record containing maintenance-relevant information is stored in individual components of the automation mechanism. This has the advantage that, after the installation of new components, their maintenance-relevant data does not need to be entered in the system, but can be transferred automatically. Subsequent revision of the maintenance-relevant information is also possible.

In addition to maintenance actions dependent on age or operating time, it is provided according to a preferred embodiment of the invention to transfer maintenance-relevant information on an event driven basis, particularly if a limit value is under- or overshot. The inventive engineering system thus enables preventive maintenance to be carried out on a time or state dependent basis, whereby modules of the automation system transmit a maintenance request to the system. The maintenance request can be generated e.g. by a sensor which detects component wear. The system also allows failure-oriented maintenance, i.e. a maintenance request is generated if a component fails. Examples of the event-based limit values according to the invention include: operating hours, filling level, voltage, electric current, threshold values for pressure, temperature, flow rate, density of fluids flowing through a pipe, ingress of foreign matter, etc.

It is provided according to the invention to incorporate all the components of an automation system, i.e. both the process control components and the automation system components, while separating the diagnostics, i.e. the provision and determination of maintenance-relevant information, from the process control system. According to the invention, the maintenance-relevant information can be displayed both on a computer provided for that purpose (maintenance station, MS), and on the process control computer (operator station, OS).

According to an advantageous embodiment of the invention, maintenance-relevant information can be displayed automatically, particularly if a maintenance action becomes necessary. If a component requires maintenance, this is displayed automatically on a maintenance station by the engineering system. In combination with a hierarchical display of the components it is provided that the maintenance request is indicated at the top level of the hierarchical structure by means of a suitable symbol. By selecting the maintenance symbol, the user is guided from level to level to the component for which the maintenance request has been generated.

The maintenance-relevant information can be stored in the engineering system in the form of data, it being possible for the data records representing the maintenance-relevant information to be stored both on a central server and in a maintenance station itself.

In a preferred embodiment of the invention, the engineering system is part of a bus system, in particular of an Ethernet and/or field bus system. The engineering system can thus be easily incorporated into an existing automation mechanism whose process control is effected via a bus system. Ethernet networks are frequently used for networking the process control computers, the components of the automation mechanism being controlled via a field bus.

The invention further relates to a method for maintaining an automation mechanism, wherein components are connected to an engineering system. According to the invention, maintenance-relevant information is determined and displayed by the engineering system. The determining and displaying of maintenance-relevant information allows predictive planning of maintenance tasks.

According to the invention, maintenance-relevant data of at least one component of an automation mechanism is entered in the engineering system. From the information entered, preventive maintenance requests can be generated by means of the engineering system according to the invention.

In a preferred embodiment of the invention, the maintenance-relevant data includes an address, a device profile and a device name. The system thus enables a component to be easily identified. Via a device profile, for example, data representing the maintenance-relevant information can be entered in the system or existing data records can be edited.

In a further development of the invention, at least one advance warning time or an advance warning limit can be set for the necessary maintenance action. According to the invention, the status of a component can be indicated via suitable symbols. If maintenance is required, it is provided to indicate this beforehand via settable advance warning times. In addition to an advance warning time for time-dependent maintenance tasks, in the case of event-based maintenance tasks, for example, an advance warning limit value for a degree of wear can be set. Thus a replacement can be ordered even before it is necessary to replace a component or part of a component, thereby enabling replacement parts supply to be optimally planned.

According to a further development of the invention, it is provided to display the maintenance actions becoming necessary in a hierarchically structured manner according to their urgency. For example, a plurality of time periods for low, average and acute maintenance requirement can be set. Thus maintenance required immediately as well as in the near and distant future can be seen at a glance. This enables the maintenance tasks to be efficiently planned.

According to a further development of the invention, the hierarchical structure is automatically determined from the structure of a process control system for an automation mechanism. If in an existing process control system for an automation mechanism the technical structure of the plant is present in the form of a hierarchical structure, according to the invention this structure is essentially used for displaying the maintenance tasks. Thus, on the one hand, manual generation of a structure for maintenance can be dispensed with and, on the other, operator control of a maintenance station is particularly simple, as users are generally familiar with the process control structure.

In a preferred embodiment of the invention, the maintenance-relevant information is displayed independently of the operation or control of the automation mechanism. Maintenance is thus separate from process control. On the one hand this allows simple retro-implementation of the method according to the invention. On the other, the system is particularly easy to operate and a process control failure has no effect on the diagnostics.

In a further development of the invention, it is provided that the process control system is displayed as a maintenance system. On implementation of the method according to the invention, the user thus essentially receives the known representation of the process control system on an operator station. As a maintenance station, the structure of the process control system is displayed independently of process-relevant information.

In a preferred embodiment of the invention, maintenance-relevant information is stored on a server and retrieved via at least one client. It is provided to store the maintenance-relevant information centrally. To increase reliability, the server can be of redundant design. On clients, components combined into component groups in a hierarchically arranged manner can be selectively selected.

As provided according to a further development of the invention, a client-specific maintenance profile can be created. The user can select particular component groups for whose maintenance he is responsible. The status of the components is updated via an adjustable repetition rate. Only the maintenance-relevant information of the selected equipment groups is then indicated on the client.

### BRIEF DESCRIPTION OF THE DRAWINGS

The invention as well as additions and further developments will now be described and explained in greater detail with reference to the accompanying drawings illustrating examples of the invention.

FIG. 1 shows a process control system.

FIG. 2 schematically illustrates the user interface of the maintenance station of an engineering system according to the invention.

FIG. 3 schematically illustrates a flowchart with the various selection options and the hierarchical structure in a maintenance station.

FIG. 4 schematically illustrates the constituent parts of a diagnostics window.

FIG. 5 schematically illustrates a window in which various components are displayed along with the relevant status.

FIG. 6 schematically illustrates the configuration of a PC station for visualizing maintenance tasks.

FIG. 7 schematically illustrates a mask for processing an individual station.

FIG. 8 shows an engineering system with separate maintenance and operator station.

FIG. 9 shows a schematic block diagram with a hierarchical structure of an engineering system according to the invention.

FIG. 10 schematically illustrates a process control system which is equipped with an engineering system according to the invention.

FIG. 11 schematically illustrates a block diagram of an engineering system according to the invention.

FIG. 12 shows a schematic flowchart for monitoring a component of an automation mechanism.

### DETAILED DESCRIPTION OF INVENTION

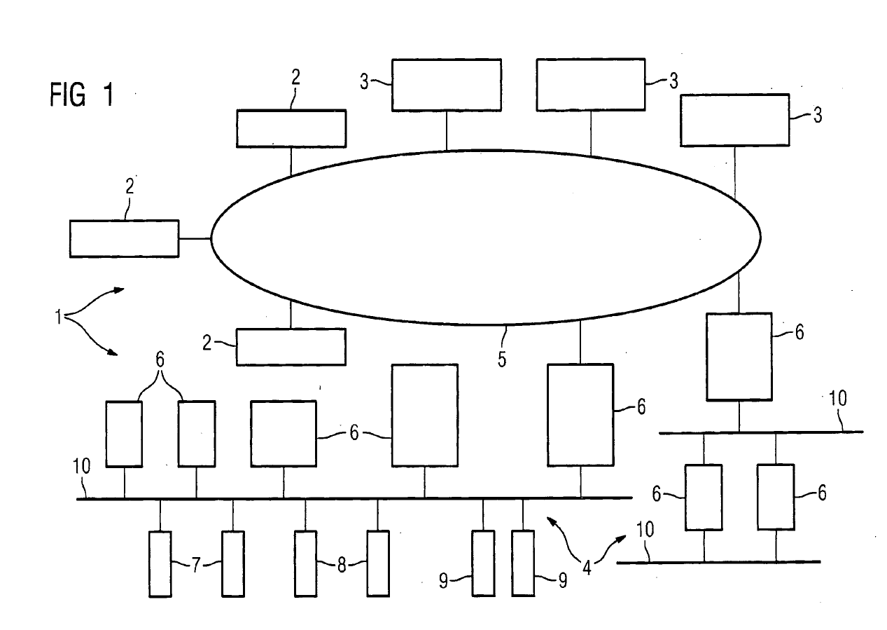

FIG. 1 shows a per se known process control system 1 comprising an engineering system 2, an operator control and monitoring system 3 and an engineered and configured automation mechanism 4, the engineering system 2 being designed for the engineering and/or configuring of the automation mechanism 4. The automation mechanism 4 which is connected to the engineering system 2 and the operator control and monitoring system 3 via a bus system 5 and bus connections (not shown) comprises different programmable controllers 6, plus actuators 7 and sensors 8 as well as other automation components 9 required for controlling an industrial plant. The programmable controllers 6, which are interconnected via the bus system 5 and/or other suitable bus systems 10, can be of different design. For example, programmable controllers for performing small, medium or larger automation tasks within the automation mechanism 4 are usually provided, micro-programmable controllers possibly being used to perform small automation tasks, mini-programmable controllers to perform medium automation tasks and high-capacity programmable controllers to perform more complex automation tasks.

The hardware and software components, i.e. the programmable controllers, operator control and monitoring equipment, bus systems, actuators and sensors, and the control programs with which the automation mechanism 4 must be provided are dependent on the complexity of the plant to be controlled and the control task, the required hardware and software components of the automation mechanism 4 being engineerable and/or configurable by the engineering system 2.

From the various hardware and software components, in particular the hardware and software components of the field devices, the engineering system 2 automatically determines maintenance-relevant data which can be displayed on a visualization system of the engineering system 2 and/or on some other visualization system connected to the bus system 5.

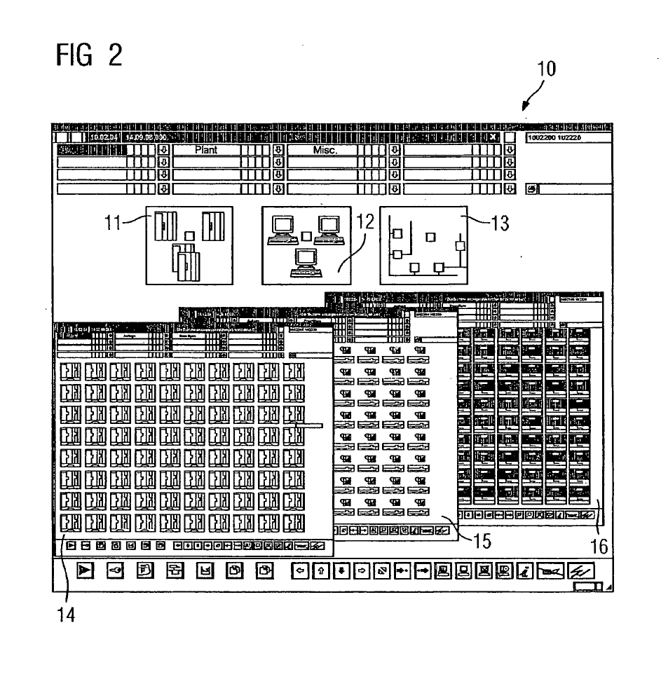

Reference will now be made to FIGS. 2 to 7 in which various displays of a maintenance area on a visualization system are shown.

FIG. 2 schematically illustrates the user interface of the maintenance station 10 of an engineering system according to the invention. The user interface of the engineering system is hierarchically structured and has, at the top level, a selection option for PC (personal computer) stations 12, network components 13 and AS (automation system) stations 11. On appropriate selection, windows 14, 15, 16 appear in which there is provided an overview of the individual components with a selection option. This hierarchical structure makes it possible for each component of a process control system to be found quickly.

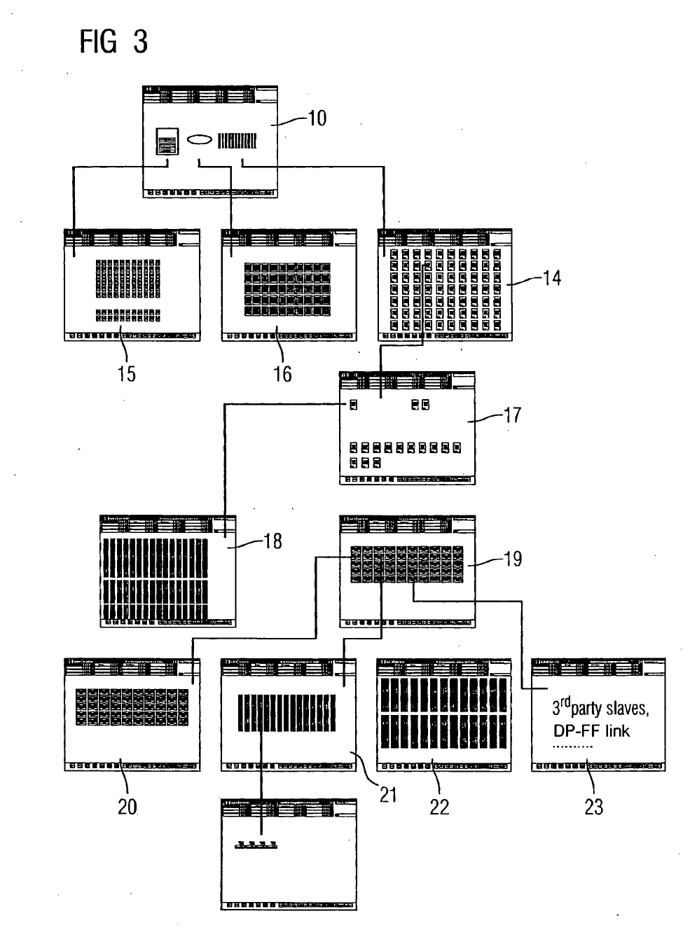

FIG. 3 schematically illustrates a flowchart with the various selection options and the hierarchical structuring of the maintenance station 10. In a first selection, the user reaches windows with an overview of the PC stations, the network components 16 and the AS stations 14. The windows 14, 15, 16 each show a selection of the individual components. The other selection options are only shown for the window of the AS stations 14. In the first window of the AS stations 14 the individual AS stations can be selected. When an individual AS station is selected, a window 17 appears which shows the individual components of the AS station. The AS station shown here comprises a central rack 18 which is connected to slaves via a Profibus DP network. In the window of the AS station 17 the central rack is selected. When the slaves are selected, a hierarchically structured window 19 appears showing the individual DP slaves. The DP slaves can in turn be selected and are then displayed in further windows 20, 21, 22, 23.

Each component of the engineering system can be selected via the hierarchical structuring.

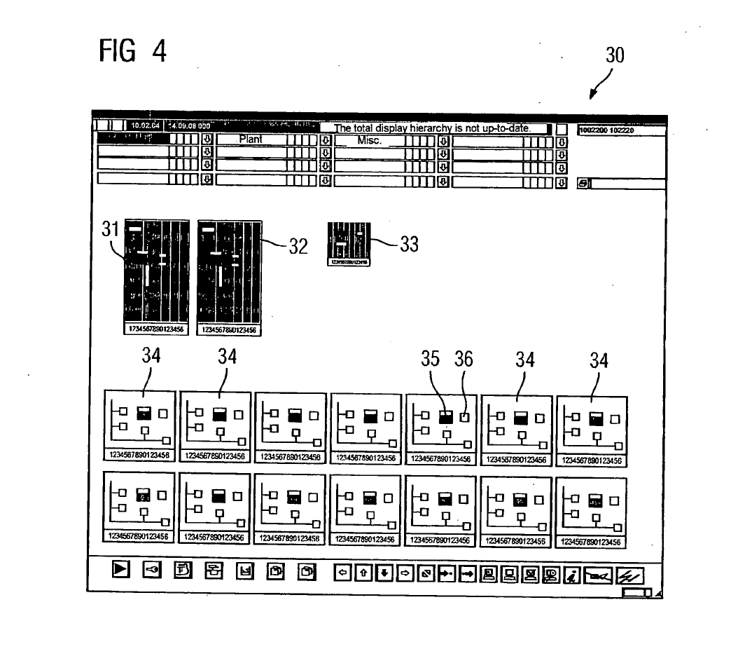

FIG. 4 schematically illustrates the component parts of a diagnostic window 30 of an engineering system according to the invention. The individual components are displayed by means of suitable graphic symbols. The example shows the display for a CPU rack comprising two racks 31, 32. An optional expansion rack 33 is provided. The subnets assigned to the rack are displayed using symbols 34 and can be selected. Each symbol of a subnet 34 includes an indication of the maintenance status of the component 35 and an indication of the maintenance status of possible lower-order device groups 36. These indications show, via a suitable graphic symbol, the current status of the component. For example, if no maintenance action is necessary in a specified time interval, the green symbol can indicate to the user that the relevant component requires no maintenance. Maintenance actions soon necessary can be represented via a yellow symbol, and an urgent maintenance requirement or a component defect via a red symbol. The particular advantage of the hierarchical structure is that a maintenance requirement can be indicated even for a lower-order component. If a device of a lower-order device group urgently requires maintenance, the corresponding symbol is displayed in the indication of the maintenance status of the lower-order device group 36. By selecting the indication 36, the user is displayed another window (not shown) in which the component requiring maintenance can be identified.

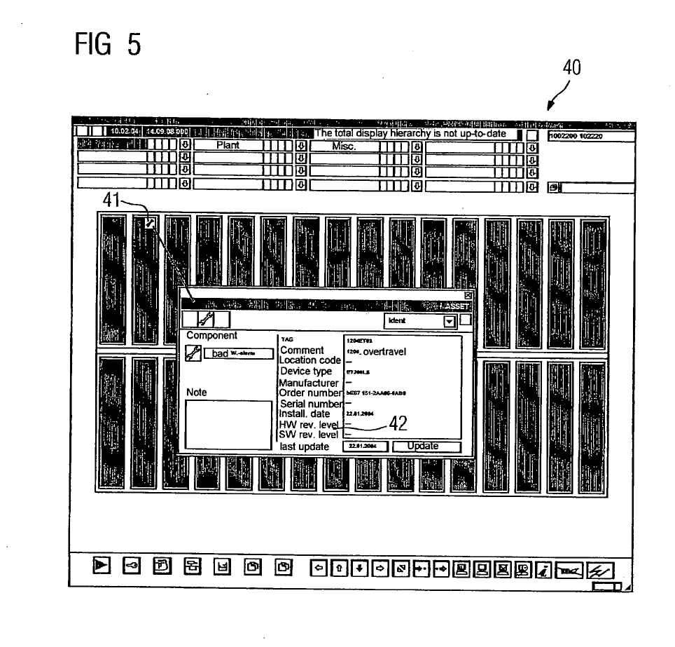

FIG. 5 schematically illustrates a window 40 in which various components are displayed along with their particular status. In this example a component has failed, which is indicated via a corresponding maintenance symbol 41. When the maintenance symbol is selected, a window 42 appears which displays further maintenance-relevant information as well as the status of the component. This information can include e.g. the serial number, the installation date, the device type, the hardware and software revision level as well as the order number for replacement.

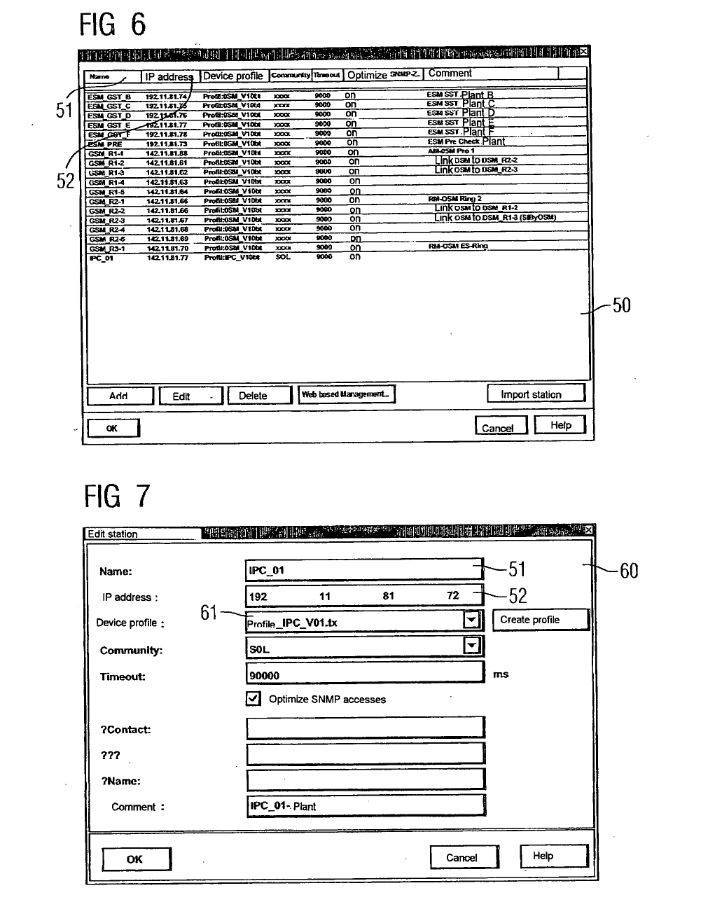

FIG. 6 schematically illustrates the configuration of a PC station for visualizing maintenance tasks. A server which determines maintenance-relevant information is linked to the PC station. The maintenance-relevant information is updated on the PC station at settable intervals, e.g. every minute. The components to be monitored can be selected via a plant configuration mask 50. The components are assigned, for example, a name 51 and an IP address 52. The individual components can be selected and edited in the plant configuration mask 50. A mask for editing an individual station 60 is shown. The station, which can be a device, a network component, etc. is unambiguously identified via an IP address 52. The station can be assigned a name 51. The device profile 61 generated can be saved under a filename.

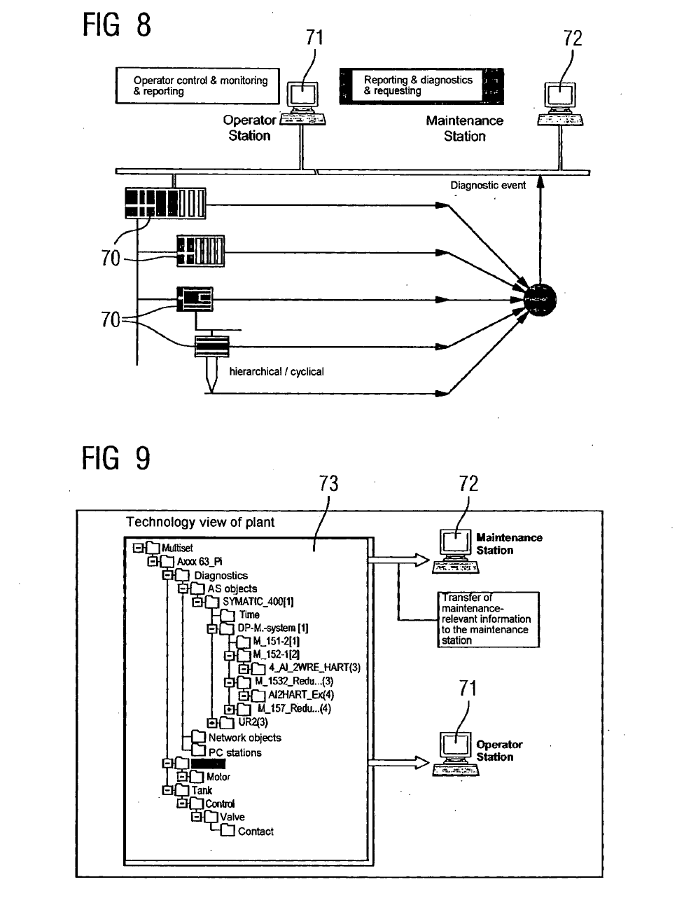

FIG. 8 explains the separation of the diagnostics and maintenance functions. Schematically illustrated is a process control system 1 comprising various components of an automation mechanism 70. Process control of the automation mechanism is provided by an OS (operator station) 71. According to the invention, a maintenance station 72 independent of the OS is provided. The maintenance station incorporates all the components of the automation device, i.e. both the process control devices and the plant components. All the components of the automation mechanism 70 are assigned uniform maintenance-relevant status indications. A time or event based diagnostic event is indicated by the maintenance station 72. Here status indications are cyclically transmitted to the maintenance station 72 by the components of the automation mechanism 70. The diagnostic events are displayed in a hierarchically structured manner by the maintenance station.

FIG. 9 shows a schematic block diagram explaining the hierarchical structure of the engineering system according to the invention. An operator station 71 is provided for process control, the components of an automation mechanism being stored and displayed in hierarchically structured form as the technology view of the plant 73. For engineering, the technology view 73 is automatically transferred to a maintenance station 72. The maintenance station 72 therefore assumes the hierarchical structure of the operator station 71 which was generated from the technology view. The maintenance station 72 is of modular design and can be operated on the same PC as the operator station, particularly in the case of smaller plants.

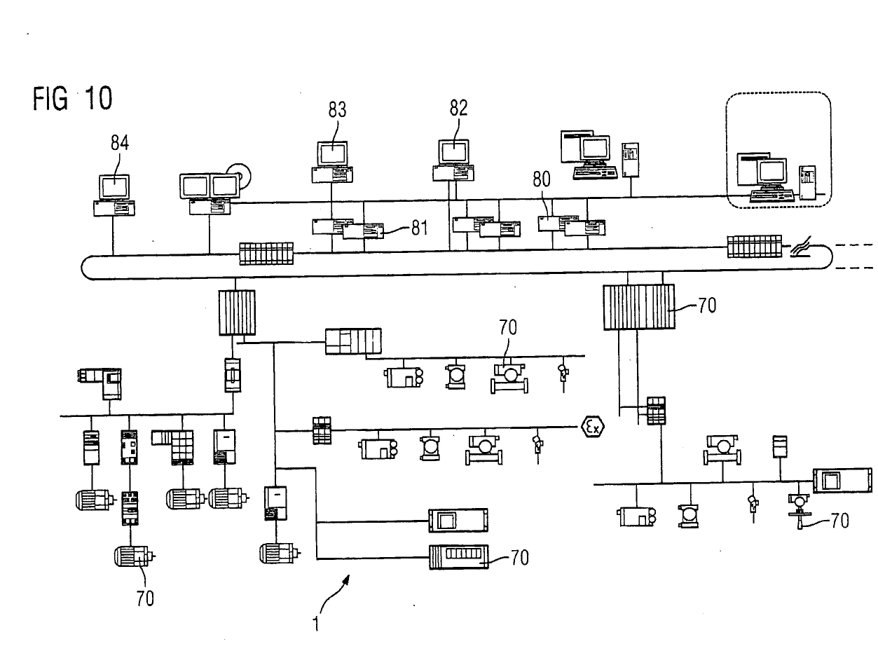

FIG. 10 shows a process control system 1 which is equipped with an engineering system according to the invention. The engineering system here comprises redundantly designed MS (maintenance system) servers 80 linked into an Ethernet network. OS (operator station) servers 81 independent of the MS server are provided for process control tasks. The maintenance area and process control are therefore separate from one another. The process control system is used to control and monitor an automation mechanism having a large number of different components 70 including both devices and network components. As the user interface for maintenance there is provided an MS client 82 which is used exclusively for maintenance of the process control system, whereas an OS client in 83 is provided exclusively as the user interface for process control. In the operating state, the MS client 82 cyclically requests the data from the MS server. In addition, the MS client 82 can access the components 70 of the automation mechanism directly via the network. The components 70 of the automation mechanism have different diagnostic capabilities. There may even be components 70 which can only be assigned time-dependent maintenance but which do not have means of self diagnostics. The MS client 82 displays all the components by means of uniform symbols representing various states. Depending on the diagnostic capability of the relevant component, different windows can be selected by the user on the MS client 82 in order to be able to display all the available maintenance-relevant information concerning the particular component. Another client 84 can be used both as an MS client and as an OS client. Because of the modular design of the system, MS and OS windows can be displayed simultaneously on the other client 84.

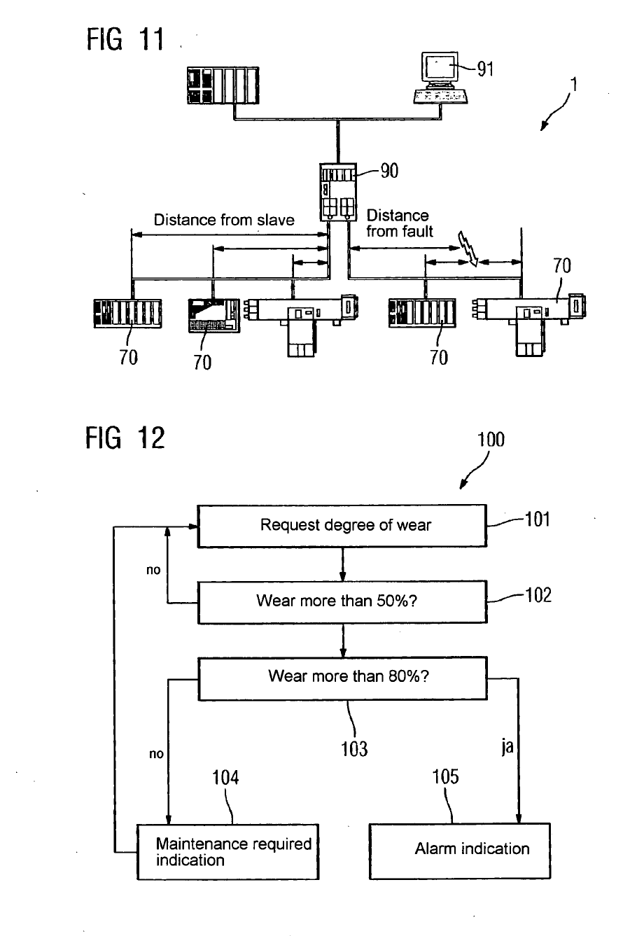

FIG. 11 schematically illustrates a block diagram of an engineering system 1 according to the invention. An engineering station 91 is connected to components of an automation mechanism 70 via a Profibus. Incorporated in the network is a diagnostic repeater 90 which continuously checks the network lines. Line breaks, signal lines short circuits to shielding as well as missing or too many inserted bus resistors are communicated to the maintenance system (not shown) via the diagnostic repeater 90. A fault indication contains details about the bus segment affected, the fault location (distance from a diagnostic repeater 92 or from a particular component 70) and the possible cause of the fault.

FIG. 12 shows a schematic flowchart 100 explaining the monitoring of a component. The degree of wear of a component is requested 101 via a maintenance station. For this purpose a component has a sensor and communicates the measured value via a network (not shown). Two threshold values can be set for the wear. The first threshold value, here set at 50%, is initially scanned 102, If the wear is less than 50%, the degree of wear is cyclically requested again 101 after a settable time period. If the wear is above 50%, a second settable threshold value is requested 103 which is higher than the first threshold value and represents an acute maintenance requirement. If the value is not above the second threshold value (here 80%), the system generates an indication that maintenance is required 104 and continues cyclically requesting the degree of wear 101. The indication that maintenance is required can be retrieved at an MS client (not shown). If the value is above the second threshold value, an alarm indication is generated 105. The system according to the invention thus allows predictive maintenance planning.

1.-22. (canceled)

23. An engineering system for an automation system to be controlled, comprising:
data required for engineering the automation system stored in the engineering system; and
a determination device to determine automatically in response to a user request from the engineered automation system, maintenance-relevant information for displaying in a diagnostics area on a visualization system.

24. The engineering system as claimed in claim 23, wherein the engineering system is used for a configuring of the automation system.

25. The engineering system as claimed in claim 23, wherein components of the automation system are displayed by symbols in images arranged in a hierarchically manner.

26. The engineering system as claimed in claim 23, wherein maintenance-relevant data of at least one component of the automation system are entered in the engineering system.

27. The engineering system as claimed in claim 26, wherein the maintenance-relevant data are determined on a time or operating time basis.

28. The engineering system as claimed in claim 23, wherein maintenance-relevant information are transferred on an event basis from at least one component of the automation system to the engineering system.

29. The engineering system as claimed in claim 28, wherein the event is based upon an undershot or an overshot of a limit value.

30. The engineering system as claimed in claim 28, wherein the maintenance-relevant information are automatically displayed if a maintenance action becomes necessary.

31. The engineering system as claimed in claim 23, wherein maintenance-relevant information is stored in the engineering system, wherein the engineering system is part of a bus system.

32. A method for maintaining an automation system having components, comprising:
connecting the components to an engineering system;
determining maintenance-relevant information by the engineering system; and
displaying maintenance-relevant information by the engineering system.

33. The method as claimed in claim 32, wherein the maintenance-relevant information of at least one component of the automation system is entered in the engineering system.

34. The method as claimed in claim 33, wherein the maintenance-relevant data includes an address, a device profile and a device name.

35. The method as claimed in claim 34, wherein the maintenance-relevant information is displayed in a hierarchical structure.

36. The method as claimed in claim 32, wherein the maintenance-relevant information is displayed in a hierarchical structure, and wherein the hierarchical structure is automatically generated at least partially based upon a structure of a process control system of the automation system.

37. The method as claimed claim 34, wherein a maintenance action becoming necessary is automatically indicated.

38. The method as claimed in claim 37, wherein at least one advance warning time is set for a necessary maintenance action.

39. The method as claimed in claim 38, wherein at least one advance warning limit is set for a necessary maintenance action.

40. The method as claimed in claim 34, wherein at least two limit values are set, corresponding to different warning stages of a maintenance action becoming necessary.

41. The method as claimed in claim 32, wherein maintenance actions becoming necessary are displayed in a hierarchical manner according to urgency.

42. The method as claimed in claim 32, wherein maintenance-relevant information is determined independently of the operation of the automation system, wherein maintenance-relevant information is stored on a server and retrieved via at least one client, and wherein a plant-specific maintenance profile is created which includes particular components or component groups of the automation system.
